(19) United States
(12) Patent Application Publication
(10) Pub. No.: US 2003/0170541 A1
(43) Pub. Date: Sep. 11, 2003

(54) Positive electrode for lithium ion cells and rocking chair type lithium ion cell using the same

(75) Inventors: Masaki Yoshio, Saga-shi (JP); Yasufumi Hideshima, Saga-shi (JP)

Correspondence Address: Jordan and Hamburg, 122 East 42nd Street, New York, NY, 10168, US

(73) Assignee: Saga Prefectural Regional Industry Support

(21) Appl. No.: 09/809,487

(22) Filed: Mar. 15, 2001

(30) Foreign Application Priority Data
Jan. 24, 2001 (JP) 2001-15841

(51) Int. Cl. H01M 4/52; H01M 4/50

(52) U.S. Cl. 429/231.3; 429/224; 429/231.4; 429/221; 429/223; 252/182.1

(57) ABSTRACT

A positive electrode for a lithium ion cell, comprising an aluminum foil, and a layer formed on the aluminum foil, wherein said layer is formed by adding 30 to 40 mass % of LiCo_{1-X}M_{X}O₂, where M is selected from the group consisting of Ni, Fe and Al, to a spinel type of lithium manganese dioxide. Also added is a conductive agent, and a binding agent. The invention also covers a rocking chair type lithium ion cell, comprising the described positive electrode, and a negative electrode formed of a graphite-containing intercalation compound.

### FIELD OF THE INVENTION

The present invention relates to a positive electrode for a lithium ion cell, and more particularly to a positive electrode including an active material made of excess lithium type heterogeneous metal-doped spinel manganese oxide for a lithium ion secondary cell in which an intercalation compound, such as metallic lithium, lithium-carbon (lithium-graphite) or the like, serves as an active material of a negative electrode. The present invention also relates to a rocking chair type lithium ion cell using such a positive electrode.

### BACKGROUND OF THE INVENTION

In addition to LiNiO₂, LiCoO₂ and LiMn₂O₄ may be used as an active material for a positive electrode in a 4-volt, high-energy density type of lithium secondary cell. Some cells using LiCoO₂ as the active material of the positive electrode have been placed on the market. However, cobalt (Co) is not suitable for mass-production along with the popularization of such cells due to its limited resource and high-cost. In view of resource and cost, manganese compounds have promise as a material of the positive electrode.

A charge/discharge curve in case of charging and discharging a spinel-structured LiMn₂O₄ positive electrode at 3 V or more is characterized in that the charge and discharge capacities of the positive electrode are substantially equal to each other and no irreversible capacity appears in the positive electrode. This characteristic is similar to that of a cobalt oxide lithium positive electrode. When a lithium ion cell is constructed by combining such a positive electrode with a carbon negative electrode, the positive electrode may maintain approximately 4 V of voltage to lithium metal, whereas the voltage of the negative electrode varies up to 1 V or more to metallic lithium at the discharge end stage due to the irreversible capacity in the carbon negative electrode. Particularly, when a graphite-containing negative electrode material is applied to enhance its capacity, the potential of the negative electrode sharply goes up, specifically to approximately 3 V by minor over-discharge, at the discharge end stage.

Since a copper foil is typically used in a collector of the negative electrode, the copper will be progressively oxidized if the potential of the negative electrode goes up to approximately 3 V under the condition coexistent with an electrolyte. The oxidization of the copper leads to creating an insulative layer on the surface of the copper collector. Then, the created oxide layer tends to exfoliate from the copper collector being maintained in metallic state, and thereby the electrical contact between the collector and an active material of the negative electrode is lost, resulting in the breakdown of the lithium ion cell.

### SUMMARY OF THE INVENTION

The present invention has been embodied with a view to the aforementioned problems. Thus, it is an object of the present invention to provide a compound positive electrode for a lithium ion cell, configured by mixing heterogeneous metal-substituted cobalt oxide lithium in an active material containing spinel-structured manganese oxide, so as to allow a lithium ion cell using a graphite-containing negative electrode to be adequately charged and discharged with maintaining the potential of the negative electrode at 0.4 V or less even at the discharge end stage, whereby a collector of the negative electrode may avoid to be electrochemically oxidized even in over-discharge.

According to a first aspect of the present invention, there is provided a positive electrode for a lithium ion cell, comprising an aluminum foil, and a layer formed on said aluminum foil, wherein said layer is formed by adding 30 to 50 mass % of LiCo_{1-X}M_{X}O₂ (where M consists either one of Ni, Fe and Al) to a spinel type lithium manganese bioxide, and additionally adding a conductive agent, and a binding agent.

According to a second aspect of the present invention, there is provided a rocking chair type lithium ion cell, comprising a positive electrode in accordance with the first aspect of the present invention, and a negative electrode formed of a graphite-containing intercalation compound.

Other features and advantages of the present invention will be apparent from the detailed description.

### DESCRIPTION OF THE PREFERED EMBODIMENT

A spinel-structured manganese oxide is an optimal material for a positive electrode of large-size lithium ion cells because of its low cost. The cells have suffered from insufficient high-temperature cycle characteristics because the manganese included in this material was undesirably dissolved in an electrolyte. However, this problem of the insufficient high-temperature cycle characteristics has been headed for a successful solution by applying excess lithium type heterogeneous metal-doped spinel manganese oxide as a substitution for the above material.

This material has 105 to 120 mA h/g of the first charge capacity and its first discharge capacity is 1 to 2 mA h/g smaller than the charge capacity. On and after the second cycle, the charge/discharge is repeated at the same capacity as the first discharge capacity and there is no difference between the charge and discharge capacities.

On the other hand, while charge and discharge capacities in a graphite-containing negative electrode may be varied depending on an electrolyte, the first charge capacity of this material is typically 360 to 380 mA h/g, and the first discharge capacity is typically 300 to 330 mA h/g. The difference between the first charge and discharge capacities is 30 to 80 mA h/g. This capacity as the difference is referred to as an irreversible capacity and is consumed to form a protective layer of lithium salt on the surface of the negative electrode. On and after the second charge/discharge, practically no protective layer is generated and thereby the charge/discharge is conducted with approximately 100% of coulombic efficiency.

When a lithium ion cell is composed of a positive electrode having 120 mA h/g of charge capacity and 118 mA h/g of discharge capacity, and a negative electrode having 360 mA h/g of charge capacity and 330 mA h/g of discharge capacity, with 3g of positive active material and 1 g of negative active material, the lithium ion cell is charged at 360 mA h/g and conversely discharged at 330 mA h/g. This discharged quantity of electricity corresponds 98% of the discharge capacity of the positive electrode and thereby 3.8 V or more of potential to lithium metal will be provided in the positive electrode itself. When the discharge end voltage of the lithium ion cell is 3V, the potential of the negative electrode to metallic lithium becomes 0.8 V. This shows that the voltage at the discharge end stage reflects the potential of the negative electrode. Thus, if this lithium ion cell is further discharged within 18 mA h/g, the positive electrode is maintained at approximately 3.8 V, whereas the potential of the negative electrode is sharply increased, resulting in corrosion of a cupper collector of the negative electrode.

A case when Al-substituted cobalt oxide lithium is added in an active material containing spinel manganese will be discussed. Al-substituted cobalt oxide lithium (LiAl_{0.2}Co_{0.3}O₂) has 160 mA h/g of the first charge capacity of this material, about 130 mA h/g of the first discharge capacity, and 30 mA h/g of the irreversible capacity. Table 1 shows each composition ratio of the aforementioned spinel compound and cobalt-containing compound, and each discharge capacity and irreversible capacity in the case when a positive electrode having 330 mA h/g of charge capacity is formed by mixing the aforementioned spinel compound and cobalt-containing compound.

As is proved from Table 1, when the ratio of LiAl_{0.2}Co_{0.3}O₂ is greater than 30%, the discharge capacity of the positive electrode becomes smaller than that of the negative electrode, and the voltage at the discharge end stage is reduced depending on the potential variation of the positive electrode. Thus, the potential of the negative electrode is not increased by minor over-discharge so that the collector of the negative electrode may be prevented from the corrosion in connection with the over-discharge.

The present invention will now be described in conjunction with particular embodiments.

In an embodiment 1, a cell has 3.38 mA h of charge capacity as far as 4.3 V or less, and this cell shows 2.98 mA h of discharge capacity when it is discharged down to 3V. When current is cut off after the discharge, the voltage of the cell goes up from 3V to 3.5 V, or by the increasing amount of about 500 mV, within one hour. On the other hand, the potential of the negative electrode shows 235 mA just after the cutoff of the current, and goes down to 222 mV, or by the decreasing amount of 5 mV, after one hour.

More specifically, the potential of the positive electrode to a lithium reference electrode is 3.235 V just after the cutoff of the current, and then recovers up to 3.72 V after one hour. This phenomenon proves that the positive electrode has a large polarization reflecting discharge characteristics of the cobalt-containing positive electrode material.

After one hour from the halt of the discharge, 0.06 mA h of over-discharge was conducted with a constant current. While the terminal voltage goes down to 2.5 V, the potential of the negative electrode showed 280 mV and never went up to the level causing the copper corrosion.

In contrast, a cell shown in the comparative example 1 having a positive electrode made only by a spinel compound had 3.38 mA h as with the embodiment 1, but showed 3.08 mA h of discharge capacity which is about 0.1 mA h lager than the embodiment 1. Just after the halt of the discharge at 3 V, the potential of the negative electrode to metallic lithium is 0.08 V, and the potential of the positive electrode derived from the terminal voltage and the potential of the negative electrode was 3.80 V. This proves that the positive electrode maintains intercalation potential of lithium ion with respect to the spinel compound.

After one hour from the halt of the discharge, 0.06 mA h of over-discharge was conducted with a constant current as with the embodiment 1. As discharged quantity of electricity is increased, the terminal voltage is reduced and the potential of the negative electrode is increased. When the discharged quantity of electricity goes up to 0.02 mA h, the terminal voltage and the potential of the negative electrode are maintained at approximately constant value of 0.05 V and 3.2 V, respectively. This proves that the negative electrode has an oxidization potential of the collector formed of cupper and thereby the corrosion of the copper collector will arise.

Thus, the discharge capacity of the positive electrode may be effectively restrained by mixing Al-doped cobalt oxide lithium having an irreversible capacity with a spinel compound, and an improved cell less subject to the affect of over-discharge may be produced by employing such a positive electrode. In the embodiment 1, the charge capacity per total weight of the active materials in the positive and negative electrodes is 87.1 mA h, whereas this charge capacity is 82.1 mA h in the comparative example 1. This proves that a cell excellent in charge capacity may be produced by mixing Al-doped cobalt oxide lithium having a larger charge capacity and a reversible capacity lager than that of a spinel compound. As shown in embodiments 2 and 3, the substitutive metal may be Fe or Ni.

Embodiment 1

NMP (N-methylpyrrolidone), in which 100 mg of PVDE (polyvinyl pyrrolidone) is dissolved, is added to carbon coated graphite having 330 mA h/g of reversible capacity and 30 mA h/g irreversible capacity, and they are sufficiently agitated to be formed in paste. The formed negative electrode paste is applied uniformly on a copper foil by use of a doctor blade. The paste on the copper foil is dried by hot air to eliminate the NMP, and then the negative electrode is completed.

0.1 g of conductive material formed of acetylene black and graphite is added in 0.60 g of excess lithium cobalt-doped spinel manganese oxide having 120 mA h/g of charge capacity and 0.40 g of Al-doped cobalt oxide lithium (LiAl_{0.2}Co_{0.3}O₂). An NMP solution including 100 mg of PVDF is added in this mixture to form a positive electrode paste. The formed paste is applied uniformly on an Al foil by use of a doctor blade, and then dried by hot air to obtain a positive electrode.

The positive and negative electrodes were pouched out to provide 18 mm of diameter, respectively. The positive electrode had 24.8 mg of active material thereon, and the negative electrode had 9.4 mg of active material thereon. The potential of the negative electrode was measured by charging and discharging a three-electrode cell having metallic lithium as a reference electrode. The charge was conducted with a constant current (0.8 mA) and a constant voltage (4.3 V, 5 hours), and the discharge was conducted with a constant current (0.8 mA). 1 molar of LiPF₆ and EC (ethylenecarbonate)-DMC (dimethylcarbonate) (volume ratio 1:2) are applied as an electrolyte. The charge capacity of the cell was 3.38 mA h. When this positive electrode was discharged down to 3 V, the discharge capacity of the cell was 2.98 mA h.

After two hours from the halt of the discharge, 0.06 mA h of over-discharge was conducted with a constant current (0.8 mA h). However, the potential of the negative electrode was maintained within 0.28 V, and it was proved that no corrosion of the collector would arise.

Embodiment 2

The charge capacity of Fe-doped cobalt oxide lithium (LiFe_{0.3}Co_{0.7}O₂) is 165 mA h/g, its discharge capacity being 125 mA h/g, and its irreversible capacitance or the difference between the charge and discharge capacities is 45 mA h.

0.30 g of Fe-doped cobalt oxide lithium and 0.1 g of conductive material formed of acetylene black and graphite are added in 0.70 g of excess lithium cobalt-doped spinel manganese oxide having 120 mA h/g of charge capacity. An NMP solution including 100 mg of PVDF is added in this mixture to form a positive electrode paste. The formed paste is applied uniformly on an Al foil by use of a doctor blade, and then dried by hot air to obtain a positive electrode.

The positive electrode was pouched out to provide 16 mm of diameter. The positive electrode had 25.3 mg of active material thereon, and the 9.4 mg of active material formed in the embodiment 1 was provided as the negative electrode. A process of charge/discharge test was same as that of the embodiment 1. The charge capacity of the cell was 3.38 mA h. When this positive electrode was discharged down to 3 V, the discharge capacity of the cell was 3.04 mA h. After two hours from the halt of the discharge, as an over-discharge was conducted with a constant current (0.8 mA h), the potential of the negative electrode slowly went up. Then, the increment ratio of the potential was enlarged at the time when 0.04 mA h of over-discharge was yielded, and the potential in 0.06 mA h of over-discharge was 1.1 V. However, the potential of the negative electrode never went up to the level causing the copper corrosion, and it was proved that no corrosion of the copper collector would arise if the over-discharge was within 2%.

Embodiment 3

The charge capacity of Ni-doped cobalt oxide lithium (LiNi_{0.2}Co_{0.3}O₂) is 165 mA h/g, its discharge capacity being 132 mA h/g, and its irreversible capacitance or the difference between the charge and discharge capacities is 39 mA h.

0.40 g of Fe-doped cobalt oxide lithium and 0.1 g of conductive material formed of acetylene black and graphite are added in 0.60 g of excess lithium cobalt-doped spinel manganese oxide having 120 mA h/g of charge capacity. An NMP solution including 100 mg of PVDF is added in this mixture to form a positive electrode paste. The formed paste is applied uniformly on an Al foil by use of a doctor blade, and then dried by hot air to obtain a positive electrode. The positive electrode was pouched out to provide 16 mm of diameter. The positive electrode had 25.0 mg of active material thereon, and the 9.4 mg of active material formed in the embodiment 1 was provided as the negative electrode. A process of charge/discharge test was same as that of the embodiment 1. The charge capacity of the cell was 3.37 mA h. When this positive electrode was discharged down to 3 V, the discharge capacity of the cell was 2.98 mA h. After two hours from the halt of the discharge, 0.06 mA h of over-discharge was conducted with a constant current (0.8 mA h). However, the potential of the negative electrode was maintained within 0.30 V, and it was proved that no corrosion of the collector would arise.

Embodiment 4

Excess lithium spinel manganese oxide was applied as a substitution for excess lithium cobalt-doped spinel manganese oxide. This compound has 113.5 mA h of first charge capacity, and 112.8 mA h/g of subsequent discharge and charge capacities. This material is combined with LiNi_{0.2}CO_{0.3}O₂ to form a mixed electrode. 0.04 g of and 0.1 g of LiNi_{0.2}Co_{0.}3O₂ and 0.1 g of conductive material formed of acetylene black and graphite are added in 0.60 g of excess lithium spinel manganese oxide. An NMP solution including 100 mg of PVDF is added in this mixture to form a positive electrode paste. The formed paste is applied uniformly on an Al foil by use of a doctor blade, and then dried by hot air to obtain a positive electrode. The positive electrode was pouched out to provide 16 mm of diameter. The positive electrode had 24.8 mg of active material thereon, and the 9.4 mg of active material formed in the embodiment 1 was provided as the negative electrode. A process of charge/discharge test was same as that of the embodiment 1. The charge capacity of the cell was 3.38 mA h. When this positive electrode was discharged down to 3 V, the discharge capacity of the cell was 2.99 mA h. After two hours from the halt of the discharge, 0.06 mA h of over-discharge was conducted with a constant current (0.8 mA h). However, the potential of the negative electrode was maintained within 0.30 V, and it was proved that no corrosion of the collector would arise.

### COMPARATIVE EXAMPLE 1

0.1 g of conductive material formed of acetylene black and graphite is added in 1.00 g of excess lithium cobalt-doped spinel manganese oxide having 120 mA h of charge capacity. An NMP solution including 100 mg of PVDF is added in this mixture to form a positive electrode paste. The formed paste is applied uniformly on an Al foil by use of a doctor blade, and then dried by hot air to obtain a positive electrode. The positive electrode was pouched out to provide 16 mm of diameter. The positive electrode had 28.1 mg of active material thereon, and the 9.4 mg of active material formed in the embodiment 1 was provided as the negative electrode.

A process of charge/discharge test was same as that of the embodiment 1. The charge capacity of the cell was 3.38 mA h. When this positive electrode was discharged down to 3 V, the discharge capacity of the cell was 3.08 mA h. After two hours from the halt of the discharge, the potential of the negative electrode continuously went up as an over-discharge was conducted with a constant current (0.8 mA). Then, when 0.02 mA h of over-discharge was yielded, the potential of the negative electrode went up to 3.2 V, and subsequently maintained this value. This potential corresponds to that causing the corrosion of the copper collector.

As described above, the present invention provides an improved positive electrode for a lithium ion cell. Further, by combining this inventive positive electrode and graphite-containing negative electrode, a lithium ion cell capable of avoiding the corrosion in a collector of the negative electrode due to over-discharge may be provided.

The present invention has been described in connection with the specific embodiments. However, many other variations and modifications may be made without departing from the concept of the present invention. Accordingly, it should be clearly understood that the foregoing embodiments are illustrative only and are not intended as limitations on the scope of the invention.

What is claimed is:

1. A positive electrode for a lithium ion cell, comprising an aluminum foil, and a layer formed on said aluminum foil, wherein said layer is formed by adding 30 to 50 mass % of LiCo_{1-X}M_{X}O₂, where M consists either one of Ni, Fe and Al, to a spinel type lithium manganese bioxide, and additionally adding a conductive agent, and a binding agent.

2. A rocking chair type lithium ion cell, comprising a positive electrode in accordance with claim 1, and a negative electrode formed of a graphite-containing intercalation compound.
